(19) United States
(12) Patent Application Publication
(10) Pub. No.: US 2015/0205496 A1
(43) Pub. Date: Jul. 23, 2015

(54) METHOD AND SYSTEM FOR VISUALIZATION OF ALGORITHMIC GUIDELINES

(71) Applicant: KONINKLIJKE PHILIPS N.V., EINDHOVEN (NL)

(72) Inventor: William Palmer Lord, Fishkill, NY (US)

(21) Appl. No.: 14/419,489

(22) PCT Filed: Aug. 9, 2013
(86) PCT No.: PCT/IB2013/056516

§ 371 Date: Feb. 4, 2015

Related U.S. Application Data
(60) Provisional application No. 61/682,947, filed on Aug. 14, 2012.

(51) Int. Cl. G06F 3/0484; G06F 19/00

(52) U.S. Cl. CPC G06F 3/04842; G06F 19/345; G06F 19/3456

(57) ABSTRACT

A system, method and non-transitory computer readable storage medium for displaying an initial visualization of an algorithm to a user, the initial visualization including a prompt for an input, receiving an input, the input being one of a user input and an automatic input and determining an updated version of the visualization in response to the input, wherein the updated version includes at least one element of the initial visualization, and one of eliminates at least one further element of the initial visualization and adds at least one further element to the initial visualization.

Individuals working in a wide variety of fields, including but not limited to the medical field, may perform tasks under the guidance of computer-implemented algorithms. The execution of such algorithms may require users to make selections and/or input values based on prompts provided to the user in a visual display of the algorithm. The visual display may then provide the user with instructions based on the inputs and the algorithm.

The exemplary embodiments described herein include a method for displaying an initial visualization of an algorithm to a user, the initial visualization including a prompt for an input, receiving an input, the input being one of a user input and an automatic input and determining an updated version of the visualization in response to the input, wherein the updated version includes at least one element of the initial visualization, and one of eliminates at least one further element of the initial visualization and adds at least one further element to the initial visualization.

The exemplary embodiments further include a system having a memory and a processor. The memory storing a plurality of algorithms and an algorithm visualization module. The processor receiving a selection of one of the plurality of algorithms, displaying an initial visualization of an algorithm to a user, the initial visualization including a prompt for an input, receiving an input, the input being one of a user input and an automatic input, and determining an updated version of the visualization in response to the input, wherein the updated version includes at least one element of the initial visualization, and one of eliminates at least one further element of the initial visualization and adds at least one further element to the initial visualization.

Another exemplary embodiment is directed to a non-transitory computer-readable storage medium storing a set of instructions executable by a processor. The set of instructions being operable to display an initial visualization of an algorithm to a user, the initial visualization including a prompt for a user input, receive a user input from the user, determine an updated version of the visualization in response to the user input, wherein the updated version includes at least one element of the initial visualization, and one of eliminates at least one further element of the initial visualization and adds at least one further element to the initial visualization and display the updated version of the visualization.

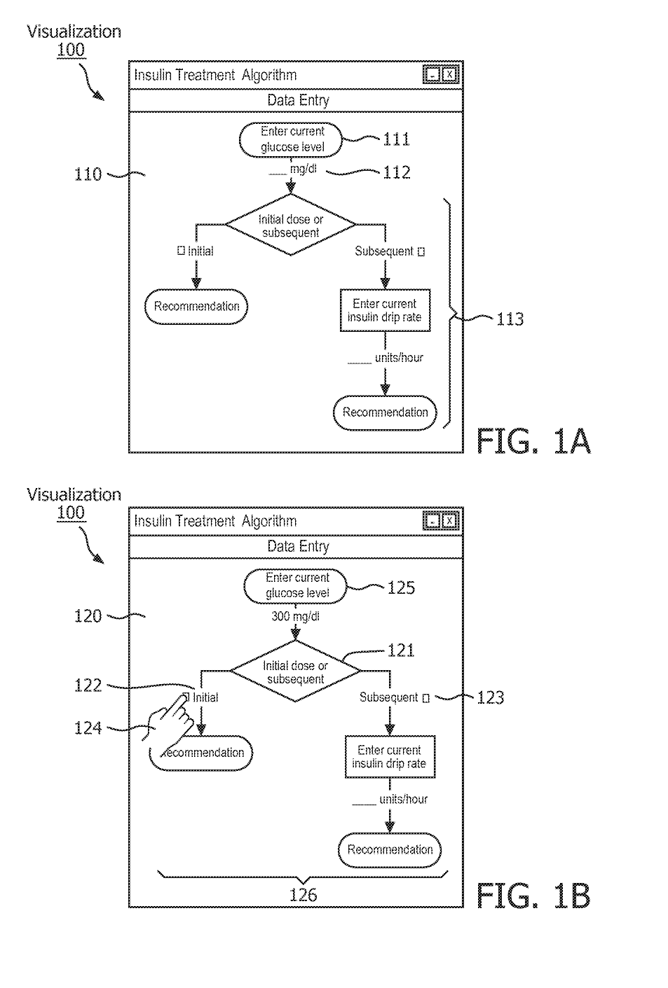

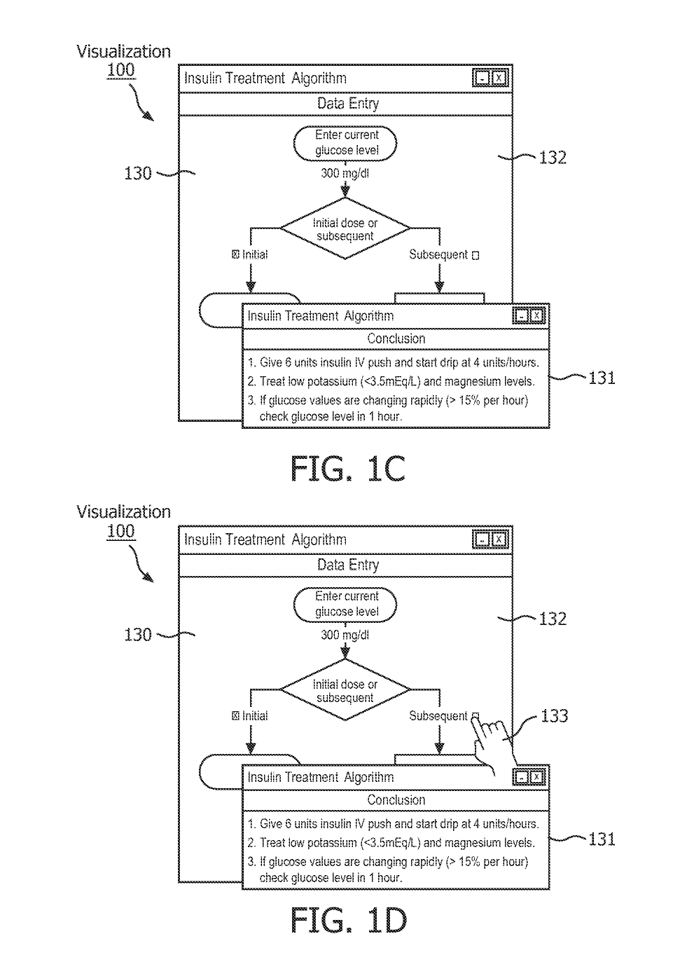

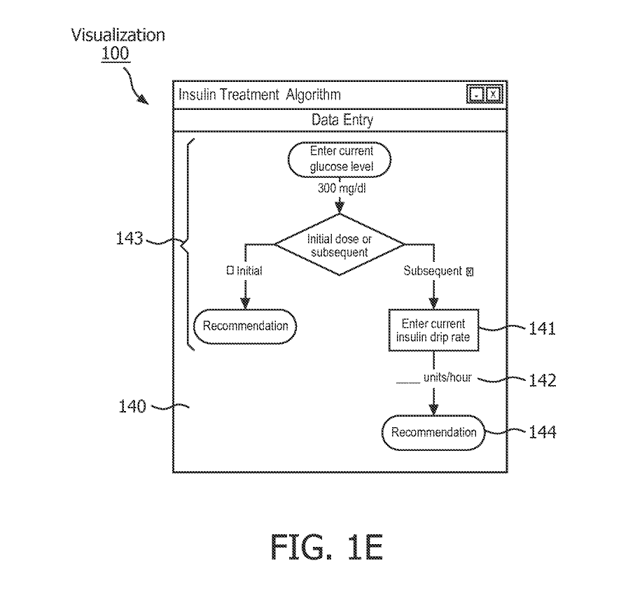

FIG. 1A shows an exemplary initial view of an exemplary first algorithm.

FIG. 1B shows a first exemplary intermediate view of an exemplary first algorithm.

FIG. 1C shows an exemplary conclusion view of an exemplary first algorithm.

FIG. 1D shows an exemplary alternative selection made from the exemplary conclusion view of FIG. 1C.

FIG. 1E shows a second exemplary intermediate view of an exemplary first algorithm based on the exemplary alternative selection of FIG. 1D.

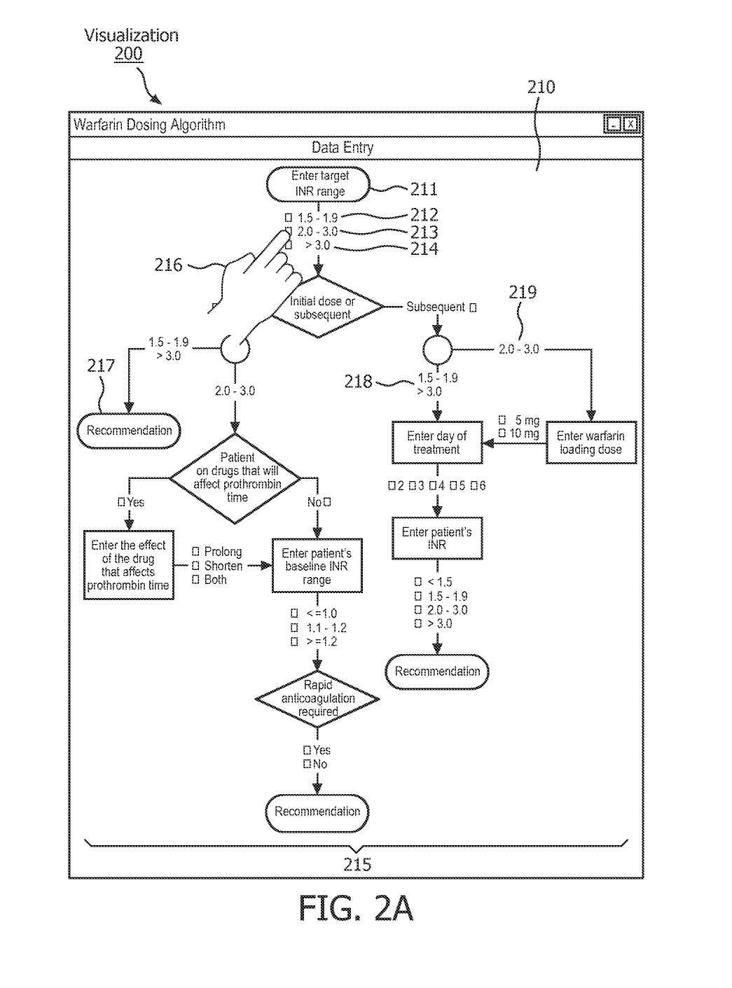

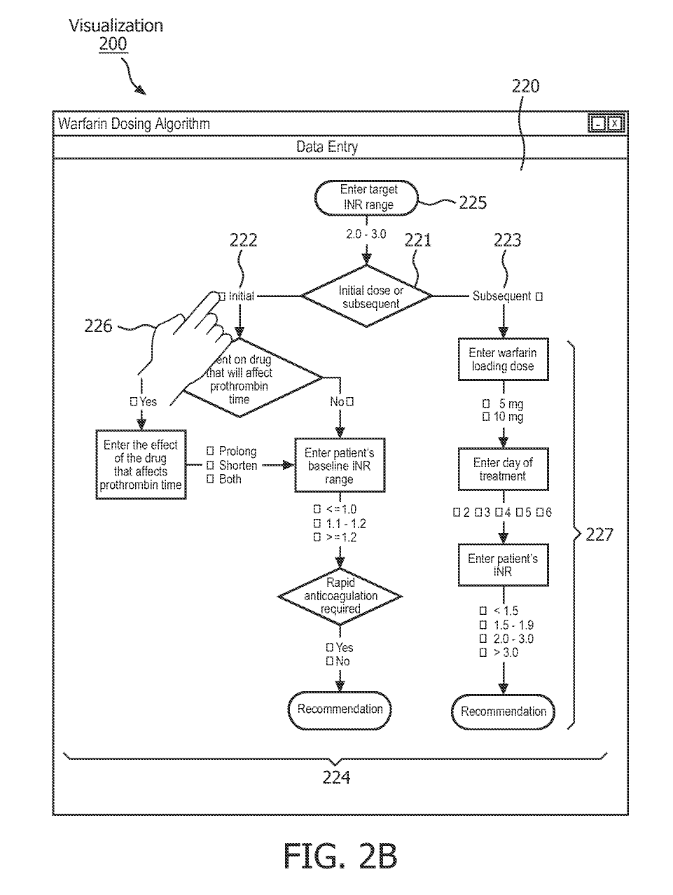

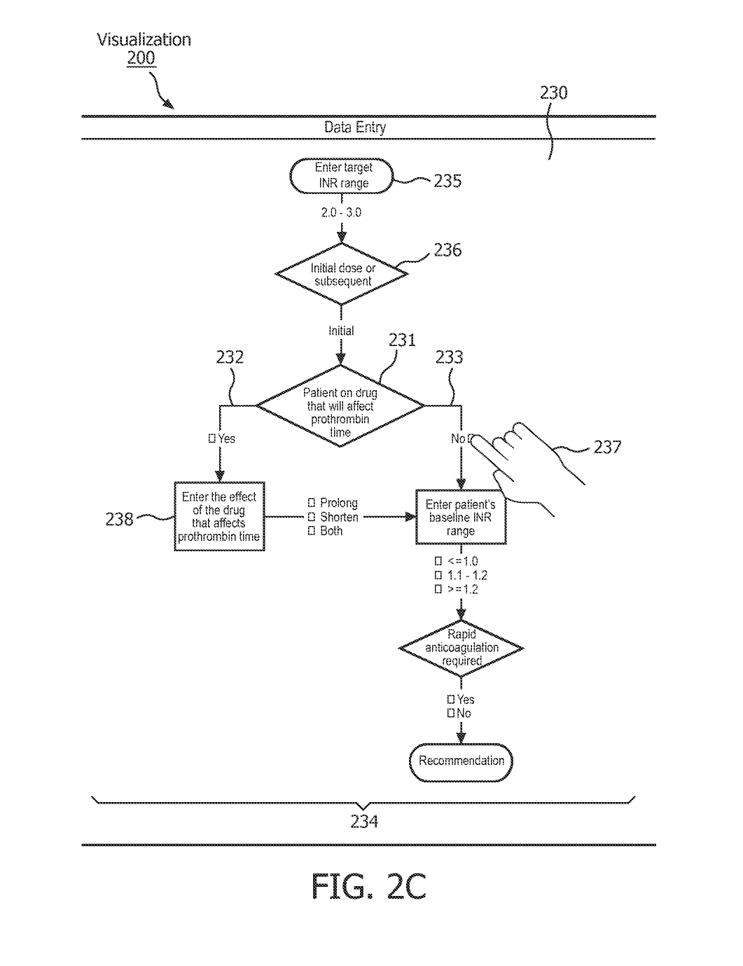

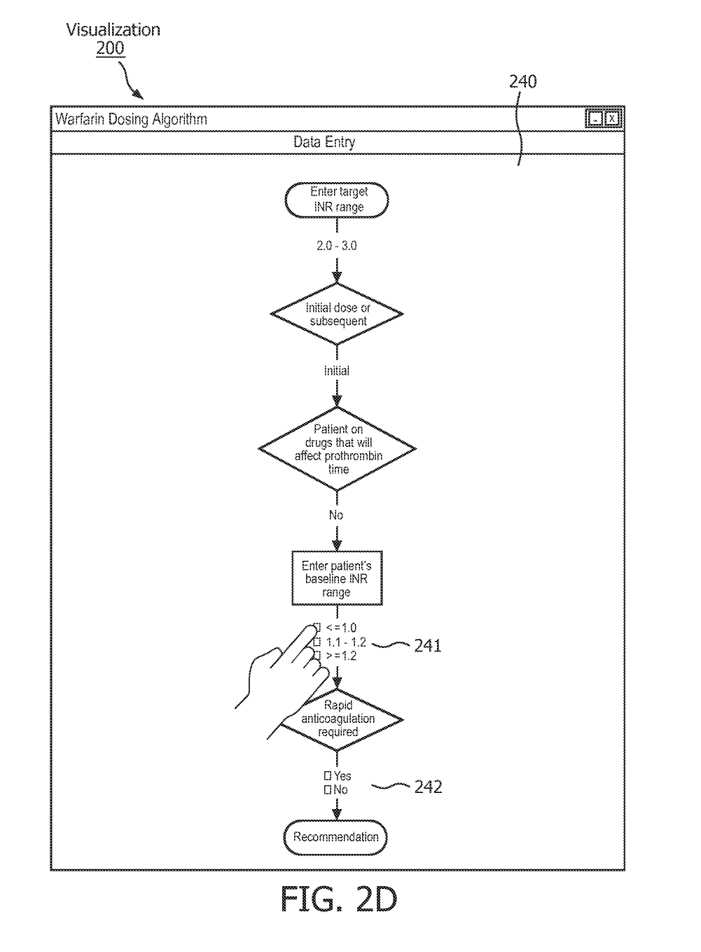

FIG. 2A shows an exemplary initial view of an exemplary second algorithm.

FIG. 2B shows a first exemplary intermediate view of the exemplary second algorithm of FIG. 2A.

FIG. 2C shows a second exemplary intermediate view of the exemplary second algorithm of FIG. 2A.

FIG. 2D shows an exemplary final view of the exemplary second algorithm of FIG. 2A.

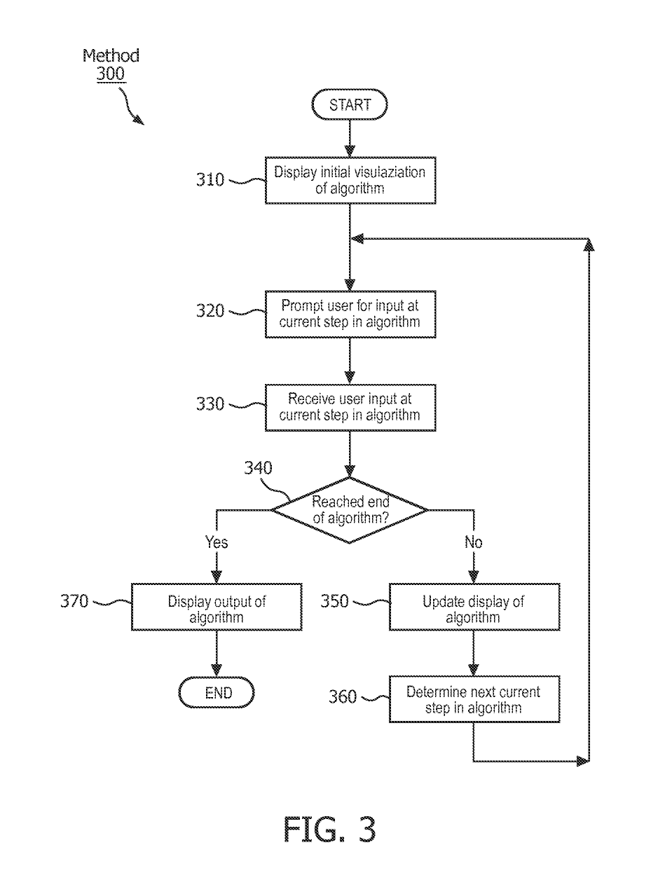

FIG. 3 shows an exemplary method for algorithm visualization.

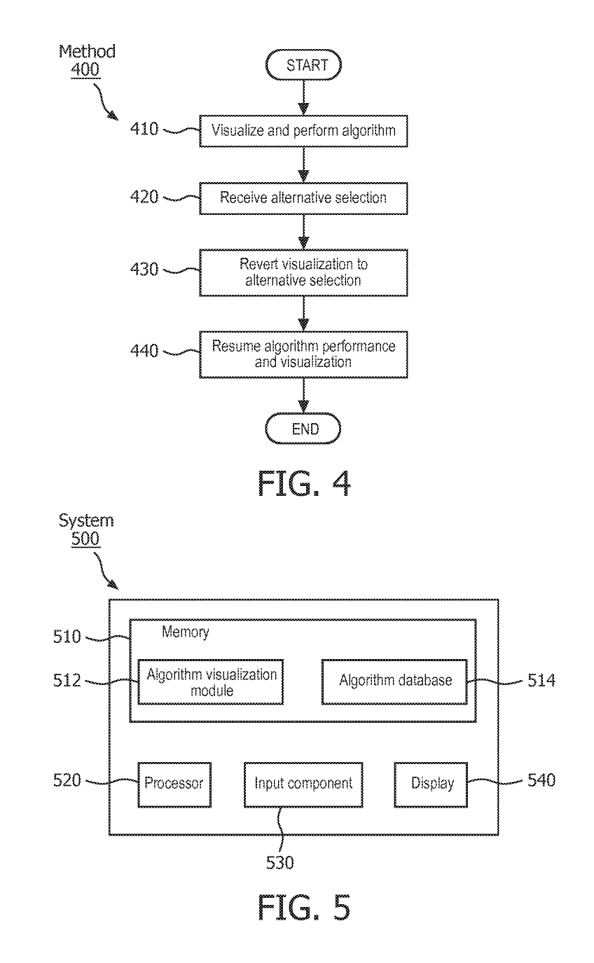

FIG. 4 shows an exemplary method for receiving an alternate selection in the exemplary method of FIG. 3.

FIG. 5 shows a schematic illustration of an exemplary system for algorithm visualization.

The exemplary embodiments may be further understood with reference to the following description of exemplary embodiments and the related appended drawings, wherein like elements are provided with the same reference numerals. Specifically, the exemplary embodiments relate to methods and systems for visualizing algorithmic guidelines during the course of execution.

Individuals performing tasks of various types may have the performance of such tasks guided by algorithms, which may alternatively be referred to as guidelines, protocols, pathways, or various other names; for clarity, the term “algorithms” shall be used herein, but those of skill in the art will understand that processes typically called by other names may also be visualized based on the exemplary embodiments described herein. Additionally, though the exemplary embodiments and figures illustrate algorithms specific to the medical field, those of skill in the art will understand that the principles described herein are equally applicable to algorithms in other fields.

Generally speaking, an algorithm may be thought of as a series of steps to be performed in a certain order. The steps and/or order may be fixed, or may be dynamically determined based on user input, or based on outcomes or calculations from previous steps. Typically, existing systems simply prompt the user for data and/or selections until a final result can be calculated, so that the user may subsequently take action based on the final result. For example, an algorithm implemented in this manner may direct a series of questions to a doctor or nurse to obtain the data required to make a determination of the severity of the condition of an ICU patient using the APACHE II algorithm.

However, existing systems for implementing an algorithm in this manner may provide a “black box” wherein users are simply prompted for input until results are reached. In such embodiments, users are not able to see or understand how algorithms branch based on inputs. Additionally, users do not understand how much data needs to be collected for an algorithm to complete. These factors lead to a frustrating experience for users. The exemplary embodiments provide algorithm visualization in a manner that results in more satisfying, less frustrating user interaction.

FIG. 1A illustrates an initial view 110 of a first exemplary algorithm visualization 100. As noted above, while the visualization 100 illustrates an algorithm for determining insulin treatment for a patient, the principles illustrated by the visualization 100 are equally applicable to other types of algorithms as well. In the initial view 110, the user is prompted by a highlighted active instruction 111, which tells the user “Enter current glucose level”. The initial view 110 also includes a highlighted active input field 112, into which the user may input a patient's current glucose level. The initial view 110 also includes non-highlighted subsequent steps 113.

After the user inputs the patient's glucose level into input field 112, the visualization automatically updates to indicate progress through the method. FIG. 1B illustrates an intermediate view 120 of the visualization 100. The intermediate view 120 includes a highlighted active instruction 121, which asks the user “Initial dose or subsequent?” To respond to this question, the user is provided highlighted selection options 122 and 123, corresponding to the options “Initial” and “Subsequent”, and the user may make a selection 124 of the appropriate option for the patient. The intermediate view 120 also includes a portion of the visualization relating to inactive steps 125, which may be shown grayed out or in another manner that indicates that they are no longer active options for the user. Additionally, the intermediate view 120 includes non-highlighted subsequent steps 126.

After the user has responded to all the prompts of the visualization 100, the user is presented with a final view 130, as illustrated in FIG. 1C. In this view, the user has selected “Initial” in response to the choice given in the intermediate view 120. The user is presented with a conclusion 131, generated as a result of the user inputs to the previous steps of the algorithm. In the final view 130, the user is presented with a blurred view 132 of the algorithm, indicating that the performance of the steps of the algorithm has completed.

Additionally, the visualization 100 may also provide the user with the ability to return to previous entries to correct entry errors and/or run what-if scenarios. FIG. 1D illustrates the user's ability to make an alternative selection 133 from the final view 130 of FIG. 1C. After such a selection, the visualization may return to the point where the alternative selection 133 was made and continue its performance. FIG. 1E illustrates a second intermediate view 140, based on a selection of “Subsequent” rather than the selection of “Initial” that led to the final view 130. In the second intermediate view 140, the user is presented with a highlighted active instruction 141, prompting the user to “Enter current insulin drip rate.” The user is also presented with a highlighted active input field 142, into which the user may input the current insulin drip rate. The second intermediate view 140 also includes inactive algorithm steps 143, which may be grayed out or otherwise altered to illustrate inactivity. In this view, both previous algorithm steps and steps relating to unselected options (e.g., “Initial”) are shown as inactive in this manner. The second intermediate view 140 also includes a non-highlighted subsequent step 144.

FIG. 2A illustrates an initial view 210 of a more complicated second exemplary algorithm visualization 200. The visualization 200 relates to an algorithm in the medical field, specifically an algorithm for determining an appropriate dosage of warfarin to be administered to a patient, but, as noted above, those of skill in the art will understand that the principles illustrated by the views 210-230 and the corresponding FIGS. 2A-2C are equally applicable to algorithms in other fields. In the initial view 210, the user is presented with a highlighted active instruction 211 reading “Enter target INR range”. The user is also presented with highlighted active options 212, 213 and 214, reading “1.5-1.9”, “2.0-3.0”, and “>3.0”, respectively. The initial view 210 also includes non-highlighted subsequent steps 215, which are not available for input during the display of the initial view 210.

The user may make a selection 216 of one of the options 212, 213 and 214 in order to advance the execution of the algorithm; in the illustration of FIG. 2A, the user has selected option 213, corresponding to an INR range 2.0-3.0. As a result, subsequent views of the visualization 200, which will be illustrated in FIGS. 2B and 2C, will reflect this selection by pruning portions of the algorithm relating to non-selected options 212 and 214. Specifically, the branch leading to recommendation 217, which is arrived at only with the selection of options 212 or 214, is removed from the visualization 200. Similarly, link 218, which also corresponds to the selection of options 212 or 214, is pruned from the visualization 200, while link 219, which corresponds to the selection of option 213, remains in the visualization 200.

FIG. 2B illustrates a first intermediate view 220 of the second visualization 200. The intermediate view 220 may be displayed after the user has made the selection 216 from the initial view 210 of FIG. 2A. The user is presented with highlighted active instruction 221, asking the user “Initial dose or subsequent”. The user is also provided with highlighted choices 222, corresponding to the selection “Initial”, and 223, corresponding to the selection “Subsequent”. As noted above, the visualization has been pruned to exclude portions of the algorithm that relate to non-selected options 212 and 214. The intermediate view 220 also includes non-highlighted subsequent steps 224, and inactive steps 225 indicated in gray or in some other manner to indicate their inactivity. In the inactive steps 225, only the selected option 213 (i.e., the range “2.0-3.0”) is shown, while non-selected options 212 and 214 have been pruned from the intermediate view 220.

The user may make a selection 226 of option 222 in the intermediate view 220, and the visualization 200 is then pruned accordingly, in the same manner as described above with reference to the selection 216. Such pruning results in the non-selected option 223 and following steps 227 being removed from the visualization 200. FIG. 2C illustrates a second intermediate view 230 of the second illustration 200. The intermediate view 230 may be displayed after the user has made the selection 216 from the intermediate view 220 of FIG. 2B. Thus, the intermediate view 230 has been pruned to exclude portions of the algorithm that relate to non-selected option 223. The user is presented with highlighted active instruction 231, asking the user “Patient on drugs that will affect prothrombin time?” The user is also presented with highlighted choices 232, corresponding to the selection “yes”, and 233, corresponding to the selection “no”. The intermediate view 230 also includes non-highlighted subsequent steps 234, and inactive steps 235 and 236 indicated in gray or in some other manner to indicate their inactivity. In the inactive steps 235 and 236, only the selected options 213 (i.e., the range “2.0-3.0”) and 222 (i.e., “Initial”) are shown, while non-selected options 212, 214 and 223 have been pruned from the intermediate view 230.

The user may make a selection 237 of option 233 in the intermediate view 233, and the visualization 200 is then pruned accordingly, in the same manner as described above with reference to the selections 216 and 216. Such pruning results in the non-selected option 232 and following step 238 being removed from the visualization 200. FIG. 2D illustrates a final view 240 of the second visualization 200. In the final view 240, all branches of the second visualization 200 have been pruned, and a straight path, showing each previous input prompt and the input received from the user, is depicted. The final view 240 may be reached before the completion of the algorithm of the visualization 200, such as if further inputs 241 and 242 are required to determine the final output, but no further branches in the algorithm remain.

In addition to the input prompts described above (i.e., entering a value and selecting between options), in other exemplary embodiments, the visualization may incorporate graphical user interface elements that are applicable to a type of input that is required from the user. For example, if the input required is a date, a calendar may be displayed; if the input required is an identification of locations where intravenous lines are located, a diagram of a body could be displayed. Additionally, an input prompt prompting a user to select between options may prompt the user with graphical options rather than textual options to choose from; for example, the user may be provided with a series of pictures of skin conditions and be prompted to choose the picture that most closely resembles the skin of a patient. Those of skill in the art will understand that these are only exemplary, and that other types of graphical user interface elements may be displayed depending on the type of input required of the user.

Further, in addition to the pruning of the visualization described above, related steps may be collapsed together at appropriate points during the visualization of an algorithm. For example, if an algorithm includes a first group of input requests for information about a patient's medical history, followed by a second group of questions about the patient's current physical examination, followed by a third group of questions about the patient's test results, each of the groups could be collapsed into a single step while the current prompt is for an input in one of the other groups, and expanded into its constituent questions when the group is currently the one for which user input is being received.

FIG. 3 illustrates an exemplary method 300 for providing a user with a visualization of an algorithm as described above. In step 310, an initial view of the algorithm is presented to the user. The initial view may be, for example, the initial view presented in FIG. 1A, described above. In step 320, the user is prompted for input at a current step, as illustrated by the highlighting of active input field 112 as shown in FIG. 1A. Those of skill in the art will understand that the prompting of input is not limited to highlighting, and may alternately be performed by showing inactive steps in darker text, displaying an arrow pointing to the active step, etc. In step 330, input relating to the current step is received from the user. As described above, this input may take the form of selecting from a plurality of options, entering a value, etc.

In step 340, a determination is made regarding whether the input received in step 330 has caused the end of the algorithm to be reached. In an embodiment wherein the method 300 is computer-implemented, this determination may be made by a processor in accordance with a program embodying the method 300 and having been configured with the specific details of the algorithm being visualized and implemented. If the end of the algorithm has not been reached, then in step 350, the display of the algorithm is updated in accordance with the input received in step 330. This updating may be, for example, similar to that illustrated in the pruning of the visualization 200 from FIG. 2A to FIG. 2B, or in another manner that is appropriate for the algorithm being visualized. For example, though the description of the visualization above discusses the pruning of a visualization of an algorithm to remove steps that have been rendered inaccessible due to an input, in another embodiment, the initial visualization may represent a simplified view of an algorithm containing a large number of steps, and a portion of the algorithm that has been omitted from the initial visualization for brevity or clarity of display may be added to a subsequent visualization once it becomes relevant, or once other portions of the visualization are pruned. In another embodiment, all future steps may be pruned from the current visualization, and only the current step may be displayed.

In step 360, the next active step is determined, as described above with reference to the visualization 200 of FIG. 2B. Once the new active step is determined, the method returns to step 320, where the user is again prompted for input at the new active step, and the method 300 may continue again through steps 330, 340, and potentially through repeated display updates in step 350 until the end of the algorithm has been reached. If, in step 340, it is determined that the end of the algorithm has been reached, the method 300 continues to step 370, where the output of the algorithm is displayed. The output may be, for example, as displayed in FIGS. 1C and 1D described above; however, those of skill in the art will understand that a textual output is only exemplary, and that in other embodiments, the output may additionally include an image (e.g., illustrating the appearance of medicine to be administered to a patient, an optimal location to give an injection, etc.) or even a multimedia output, such as a video clip of an expert describing and/or demonstrating the action to be taken based on the outcome of the algorithm.

Additionally, as described above with reference to FIGS. 1D and 1E, the exemplary embodiments may enable a user to return to an earlier point in an algorithm to correct an entry error or determine results of the algorithm if a different selection had been made. FIG. 4 illustrates an exemplary method 400 by which such alternate options may be provided to a user. In step 410, an algorithm is visualized and executed, in a manner such as that described above with reference to method 300. This may result in an output such as that described above and shown in FIG. 1C. In step 420, the user selects an alternative option from one that had been selected during the performance of the algorithm in step 410. This selection may be made in the manner of the alternative selection 133 described above and illustrated in FIG. 1D. In step 430, the algorithm visualization is reverted to the point of the alternative selection, and any inputs by the user subsequent to the previously-made selection are considered void. This reversion may be performed in the manner described above and illustrated in FIG. 1E. In step 440, normal visualization and execution of the algorithm resume at the point of the alternative selection, i.e., performance of the method 300 may resume at this point. After step 440, the method 400 terminates.

As described above with reference to step 340 of method 300, the exemplary method 300 may be computer-implemented. FIG. 5 schematically illustrates an exemplary system 500 for implementation of the exemplary method 300. The system 500 includes a memory 510, which may be any type of non-transitory media suitable for storing data as described herein. The memory 510 includes an algorithm visualization module 512, which may be a program consisting of lines of code that are operative to perform the method 300 described above, or a similar method. The system 500 may be operable to visualize a variety of algorithms. Thus, the memory 510 also includes an algorithm database 514 storing a plurality of algorithms that may be loaded by a user of the system 500 for visualization. In some embodiments, users of the system 500 may modify the algorithms stored in the algorithm database 514; in other embodiments, storage of the algorithms may be read-only; in still other embodiments, a system of permissions may be implemented to allow certain users to modify the algorithms stored in the algorithm database 514, while others are only allowed to access them on a read-only basis.

The system 500 also includes a processor 520, which executes the algorithm visualization module 512 and performs other processing tasks. The system 500 also includes an input component 530, by which users may select an algorithm from the algorithm database 512 and enter input into the visualizations generated by the algorithm visualization module 512. The input component 530 may include, for example, a keyboard, a mouse, a touch screen, or any other input means known in the art. The system 500 also includes a display 540, which displays the algorithm visualization and its output to a user. The display 540 may be touch-sensitive or non-touch-sensitive, and may be any type of display known in the art. In one embodiment, the input component 530 and the display 540 may be integrated into a touch-screen display. Those of skill in the art will understand that in some embodiments, the system 500 may be a dedicated system for performing algorithm visualization, while in other embodiments, the system 500 may be a system that performs various other tasks, either concurrently with the execution of the algorithm visualization module 512, or at other times.

The exemplary embodiments may enable users of a visualization system such as the system 500 of FIG. 4 to follow and perform the steps of an algorithm in a visual manner that may be easier to comprehend than a simple static textual or graphical (e.g., printout of a flowchart) visualization of the algorithm. This may be useful in the medical field, where many patient treatment protocols require information from a user to determine the course of treatment by means of an algorithm, but is equally applicable to an algorithm to be followed in any other field. This visualization method may provide the user with a greater understanding of the amount of data that needs to be collected, the current place in the algorithm, and the manner in which the algorithm branches based on inputs. The user's greater understanding may in turn result in greater expertise and more effective performance by the user.

Those of skill in the art will understand that the above-described exemplary embodiments may be implemented in any number of matters, including as a software module, as a combination of hardware and software, etc. For example, the exemplary methods 300 and 400 may be embodied in a program stored in a non-transitory storage medium and containing lines of code that, when compiled, may be executed by a processor. Further, it should be noted that, while the above-described exemplary embodiments make reference to the receipt of user input to advance the progress of an algorithm, in other embodiments, input may come from a database or a patient sensor; in such embodiments, the visualization may alert the user of the receipt of such an input, in order to ensure that the user remains apprised of the progress of the algorithm.

It is noted that the claims may include reference signs/numerals in accordance with PCT Rule 6.2(b). However, the present claims should not be considered to be limited to the exemplary embodiments corresponding to the reference signs/numerals.

It will be apparent to those skilled in the art that various modifications may be made to the exemplary embodiments, without departing from the spirit or the scope of the invention. Thus, it is intended that the present invention cover modifications and variations of this invention provided they come within the scope of the appended claims and their equivalents.

1. A method, comprising:
displaying a first version of a visualization of an algorithm including a series of steps to a user, the first version of the visualization including an active prompt for an input in a first step of the algorithm;
receiving an input at the active prompt, the input being one of a user input and an automatic input;
determining and displaying an updated version of the visualization in response to the input, wherein the updated version includes at least one element of the first version of the visualization, the element comprising a portion relating to the first step shown as an inactive step, and one of eliminates at least one further element of the first version of the visualization and adds at least one further element to the first version of the visualization;
receiving a selection of the first step of the algorithm shown as an inactive step in the updated version of the visualization; and
reverting the visualization to the first version of the visualization corresponding to the first step in response to the selection.

2. The method of claim 1, further comprising:
determining whether the first input results in a completion of the algorithm; and
displaying, if the input results in a completion of the algorithm, an output of the algorithm to the user, the output being determined based on the input.

3. (canceled)

4. The method of claim 2, further comprising:
displaying, if the input does not result in a completion of the algorithm, the updated version of the visualization to the user, the updated version of the visualization including a further prompt for a further input;

5. The method of claim 1, wherein the input is a user input, and wherein the user input includes one of a selection from a plurality of textual options, a selection from a plurality of graphical options, an entry of a textual value, an entry of a numeric value, and a selection of a date from a calendar.

6. The method of claim 1, wherein the input is an automatic input, and wherein the automatic input is received from one of a data storage and a patient sensor.

7. The method of claim 1, wherein the updated version of the visualization eliminates at least one further element of the first version of the visualization, and wherein the eliminated element of the first version of the visualization is one of an eliminated unselected branch of the algorithm, an eliminated portion of a selected branch of the algorithm that is unavailable due to the input, and a truncation of a group of inactive steps into a single step.

8. (canceled)

9. A system, comprising:
a memory storing a plurality of algorithms, each algorithm including a series of steps, and an algorithm visualization module; and
a processor receiving a selection of one of the plurality of algorithms, displaying a first version of a visualization of the selected algorithm to a user, the first version of the visualization including an active prompt for an input in a first step of the algorithm, receiving an input at the active prompt, the input being one of a user input and an automatic input, determining and displaying an updated version of the visualization in response to the input, wherein the updated version includes at least one element of the first version of the visualization, the element comprising a portion relating to the first step shown as an inactive step, and one of eliminates at least one further element of the first version of the visualization and adds at least one further element to the first version of the visualization, receiving a selection of the first step of the algorithm shows as an inactive step in the updated version of the visualization; and reverting the visualization to the first version of the visualization corresponding to the first step in response to the selection.

10. The system of claim 9, wherein the processor determines whether the input results in a completion of the algorithm and, if the input results in a completion of the algorithm, displays an output of the algorithm to the user, the output being determined based on the input, and the output particularly being one of a text output and a multimedia output.

11. (canceled)

12. The system of claim 10, wherein, if the input does not result in a completion of the algorithm, the processor displays the updated version of the visualization to the user, the updated version of the visualization including a further prompt for a further input.

13. The system of claim 9, further comprising:
an input component for receiving input from a user, wherein the user input includes one of a selection from a plurality of textual options, a selection from a plurality of graphical options, an entry of a textual value, an entry of a numeric value, and a selection of a date from a calendar.

14. The system of claim 9, wherein the input is an automatic input, and wherein the automatic input is received from one of a data storage and a patient sensor.

15. The system of claim 9, wherein the updated version of the visualization eliminates at least one further element of the first version of the visualization, and wherein the eliminated element of the first version of the visualization is one of an eliminated unselected branch of the algorithm, an eliminated portion of a selected branch of the algorithm that is unavailable due to the input, and a truncation of a group of inactive steps into a single step.

16. (canceled)

17. A non-transitory computer-readable storage medium storing a set of instructions executable by a processor, the set of instructions being operable to:
display a first version of a visualization of an algorithm including a series of steps to a user, the first version of the visualization including an active prompt for a user input in a first step of the algorithm;
receive a user input from the user at the active prompt;
determine and display an updated version of the visualization in response to the user input, wherein the updated version includes at least one element of the first version of the visualization, the element comprising a portion relating to the first step shown as an inactive step, and one of eliminates at least one further element of the first version of the visualization and adds at least one further element to the first version of the visualization;
receive a selection of the first step of the algorithm shown as an inactive step in the updated version of the visualization; and
revert the visualization to the first version of the visualization corresponding to the first step in response to the selection.

18. The non-transitory computer-readable storage medium of claim 17, wherein the set of instructions is further operable to:
determine whether the user input results in a completion of the algorithm, and
display, if the user input results in a completion of the algorithm, an output of the algorithm to the user, the output being determined based on the user input.

19. (canceled)

20. The non-transitory computer-readable storage medium of claim 18, wherein the set of instructions is further operable to:
display, if the user input does not result in a completion of the algorithm, the updated version of the visualization to the user, the updated version of the visualization including a further prompt for a further user input.
